(19) United States
(12) Patent Application Publication
(10) Pub. No.: US 2019/0257442 A1
(43) Pub. Date: Aug. 22, 2019

(54) INTEGRATED PRESSURE CONTROL DEVICE AND COLLECTION VESSEL FOR COMPRESSIBLE FLUID EXTRACTION

(71) Applicant: Waters Technologies Corporation, Milford, MA (US)

(72) Inventors: Michael O. Fogwill, South Grafton (YS); Keith Fadgen, Hope Valley, RI (US); Scott Kelley, Brookline, MA (US); Joseph D. Michienzi, Plainville, MA (US)

(21) Appl. No.: 16/277,737

(22) Filed: Feb. 15, 2019

Related U.S. Application Data
(60) Provisional application No. 62/632,889, filed on Feb. 20, 2018.

(51) Int. Cl. F16K 31/126; F16K 7/17

(52) U.S. Cl. CPC F16K 31/1266; F16K 15/00; F16K 7/17

(57) ABSTRACT

A pressure control device for use with a compressible fluid extraction system is provided, which includes a body portion integrated with a first vessel, and a pressure control element configured to control a first pressure of a second vessel upstream of the first vessel, wherein a decompression event occurs at a point of decompression proximate an outlet of the pressure control element of the pressure control device, wherein an analyte soluble in an extraction solvent stream at the first pressure but has reduced solubility in the extraction solvent stream at the pressure resulting from the decompression event drops out of solution and into the first vessel at the point of decompression Furthermore, an associated extraction system and method is also provided.

### CROSS-REFERENCE TO RELATED APPLICATIONS

This application claims priority to U.S. Provisional 62/632,889 filed on Feb. 20, 2018 and titled “Integrated Pressure Control Device and Collection Vessel for Compressible Fluid Extraction,” the entirety of which is incorporated by reference herein.

### FIELD OF TECHNOLOGY

The following relates to embodiments of an extraction system, and more specifically to embodiments of an integrated pressure control device and collection vessel.

### BACKGROUND

Transporting an analyte using a compressible solvent requires careful consideration of the pressure of the solvent. For example, in compressible fluid extraction systems such as supercritical fluid extraction (SFE), the extraction solvent is often saturated with analyte. Because the pressure of the fluid directly relates to solvating power, improperly managed changes in pressure can cause a reduction of analyte solubility in the solvent which can result in precipitation, system plugging, carryover, and other undesirable consequences. In SFE, system pressure is often controlled by a back pressure regulator (BPR). After the BPR, the solvent stream is directed to an analyte collection vessel. The low-pressure transport after the BPR into the collection vessel promotes undesirable loss of analyte solubility.

Thus, a need exists for an apparatus and method for eliminating the low-pressure transport volume in the extraction system.

### SUMMARY

A first aspect relates generally to a pressure control device for use with a compressible fluid extraction system (i.e. a supercritical fluid extraction system), comprising: a body portion integrated with a first vessel; and a pressure control element configured to control a first pressure of a second vessel upstream of the first vessel, wherein a decompression event occurs at a point of decompression proximate an outlet of the pressure control element of the back pressure regulator, wherein an analyte soluble in an extraction solvent stream at the first pressure but is having a reduced solubility in the extraction solvent stream at the pressure resulting from the decompression event drops out of solution and into the first vessel at the point of decompression.

A second aspect relates generally to an extraction system comprising: an extraction vessel, wherein a sample is placed within the extraction vessel and pressurized with an extraction solvent, at a first pressure, a first pressure control device in fluid communication with the extraction vessel via an extraction fluidic connection line, and configured to control a target pressure of the extraction vessel, the first pressure control device being integrated with a first collection vessel, the first collection vessel having a second pressure, which is a lower pressure state than the first pressure, wherein the first pressure control device is integrated with the first collection vessel so that at a point of decompression from the first pressure to the second pressure, an analyte with reduced solubility resulting from a drop in pressure or drop in density is immediately collected in the first collection vessel.

A third aspect relates generally to a method for reducing post-compression transport volume of a compressible fluid extraction system, the method comprising: integrating a pressure control device with a collection vessel, wherein a point of decompression from a high pressure state to a low pressure state proximate a pressure control element of the pressure control device is positioned within the collection vessel, in an operable configuration of the compressible fluid extraction system, and collecting an analyte at the point of decompression when the analyte has reduced solubility in an extraction solvent stream at a pressure resulting from a decompression event at the point of decompression.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a schematic view of a current extraction system;

FIG. 2 depicts a cross-sectional view of a back pressure regulator associated with the current extraction system;

FIG. 3 depicts a schematic view of an extraction system, in accordance with embodiments of the present invention;

FIG. 4 depicts a cross-sectional view of a back pressure regulator integrated with a collection vessel, in accordance with embodiments of the present invention;

FIG. 5 depicts an enlarged cross-sectional view of the back pressure regulator being integrated with a collection vessel as shown in FIG. 4, in accordance with embodiments of the present invention;

FIG. 6 depicts an enlarged cross-sectional view of a point of decompression of the back pressure regulator integrated with the collection vessel of FIG. 5, in accordance with embodiments of the present invention; and

FIG. 7 depicts a flow chart of a method for reducing post-compression transport volume of a compressible fluid extraction system, in accordance with embodiments of the present invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

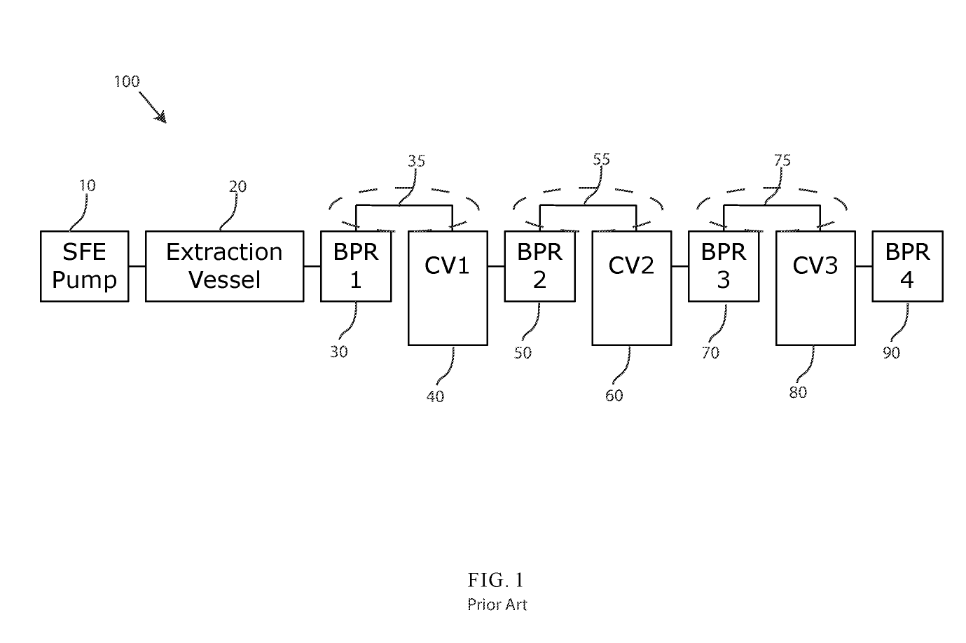

Referring to the drawings, FIG. 1 depicts a current extraction system 100. The extraction system 100 may be a supercritical fluid extraction system for extracting chemical compounds using a compressible solvent, such as carbon dioxide, instead of an organic solvent. The extraction system 100 includes a pump 10, an extraction vessel 20, a first back pressure regulator 30, a first collection vessel 40, a second back pressure regulator 50, a second collection vessel 60, a third back pressure regulator 70, a third collection vessel 80, and a fourth back pressure regulator 90. The first back pressure regulator 30 is fluidly connected to the first collection vessel 40 via a line 35, the second back pressure regulator 50 is fluidly connected to the second collection vessel 60 via a line 55, and the third back pressure regulator 70 is fluidly connected to the third collection vessel 80 via a line 75. Moreover, extraction system 100 may use a highly compressible solvent, such as CO₂, to dissolve a sample placed in the extraction vessel 20 by pressurizing the extraction vessel with the compressible extraction solvent. The resultant extraction solvent stream containing the fully soluble analyte and the extraction solvent is transferred to a collection vessel, where the extraction stream is depressurized, which causes the extraction solvent to lose solvating power.

A density of the extraction solvent used in the extraction system 100 is directly related to the solvating power of the extraction solvent. The density of the extraction solvent can be controlled by changing a temperature and pressure. Accordingly, any change in pressure may result in a change in solvating power of the extraction solvent. As such, a drop in system pressure may result in a drop in analyte solubility in the extraction solvent stream. Because extraction system 100 may often operate at a limit of analyte solubility, a drop in pressure can result in an analyte dropping out of solution. For example, an analyte may drop from solution and form a two phase mixture. A liquid can fall from the solution or a solid can precipitate from the solution. The formation of such a biphasic system can result from a relatively small reduction in solubility and may not imply complete separation of the analyte from the solvent. This effect can be leveraged by extraction system 100 to perform density-based fractionation of analytes. Further, a stepwise reduction in pressure results in stepwise collection of analyte fractions based on solubility in the extraction solvent stream at various pressures. In some instances, the extraction system 100 employs four different pressure zones. The first pressure zone is the extraction vessel (EV) 20 and is controlled at a target pressure by the first back pressure regulator (BPR1) 30. The second pressure zone, the third pressure zone, and the fourth pressure zone are associated with the three collection vessels (CV1, CV2, CV3) 40, 60, 80. The collection vessels 40, 60, 80 are each controlled by independent back pressure regulators 50, 70, 90. A difference in pressure from CV1 40 to CV2 60 to CV3 80 provides the ability to fractionate. For example, an analyte soluble in the fluid pressure in the EV 20 but has reduced solubility in the fluid pressure in CV2 60 would drop out from solution and collect in CV2 60. In some extraction systems that do not employ density-based fractionation may have only a two pressure zones, the EV and the CV, each controlled by a BPR. In some cases, the collection vessel may be operated at ambient pressure and therefore does not require a pressure control device, such as a back pressure regulator. Further, systems employing density-based fractionation may have at least two pressure zones, controlled by at least one pressure control device.

A limitation to the extraction system 100 design results from a design of the back pressure regulators 30, 50, 70, 90. For instance, back pressure regulators 30, 50, 70, 90 are either designed in a way or were repurposed from other industries in a way that requires a placement at a considerable distance from the collection vessels 40, 60, 80, as shown schematically in FIG. 1. As such, a length of connective tubing (e.g. line 35, 55, 75) has to be placed from an outlet of the back pressure regulators 30, 50, 70, 90 to an inlet of the collection vessels 40, 60, 80. Because a depressurization event occurs in the back pressure regulators 30, 50, 70, 90, the analyte can drop from solution inside line 35, 45, 75 connecting the back pressure regulators 30, 50, 70, 90 and the collection vessels 40, 60, 80. The lines 35, 55, 75 connecting the back pressure regulators 30, 50, 70, 90 and the collection vessels 40, 60, 80 may be referred to as low-pressure transport or post-decompression system volume. The low-pressure transport tubing of extraction system 100 is highlighted with dashed-line circles in FIG. 1. Such low-pressure transport is undesirable because an insoluble analyte can collect in unswept areas of fittings and/or plug the low-pressure transport tubing 35, 45, 75. For example, analyte soluble in extraction stream at first pressure may become less soluble in the extraction stream at a lower pressure due to a reduced solvating power of the extraction solvent. A decompression event or pressure drop from a first pressure to a second, lower pressure may occur within the back pressure regulator 30, 50, 70, 90, resulting in an analyte dropping out of the extraction solvent solution, which is then transported through lines 35, 55, 75 to a next collection vessel 40, 60, 80. The insoluble analyte may thus block or partially block the fluid pathways and adversely affect the extraction system 100, as well as reduce a yield of a particular compound within the collection vessel 40, 60, 80, and contribute to carryover and/or contamination of subsequent extraction runs. Extensive cleaning of the extraction system is often required between runs to prevent such problems.

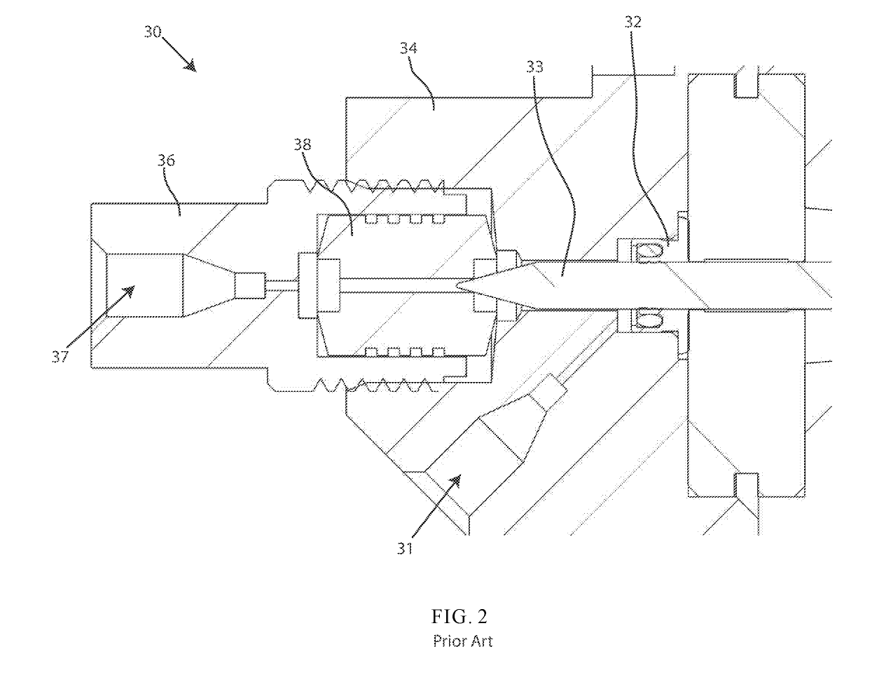

Further, back pressure regulators 30, 50, 70, 90 are currently designed to require a length of tubing 35, 55, 75 to connect to the collection vessels 40, 60, 80. FIG. 2 depicts a cross-sectional view of a back pressure regulator 30 associated with extraction system 100. The back pressure regulator 30 includes a fluid inlet 31, a seal 32, a needle 33, a head 34, a seat 38, an outlet nut 36, and a fluid outlet 37. An extraction stream (e.g. mobile phase) may enter the back pressure regulator 30 via inlet 31 under a certain pressure, and flow through the back pressure regulator 30 and fill around the seal 32, and pass around the needle 33 and through an orifice between the needle 33 and the seat 38. As the extraction stream passes from the orifice within the back pressure regulator 30 to a fluid pathway of the outlet nut 36, a decompression event occurs, wherein a pressure is abruptly reduced. Thus, the decompression event occurs at a point of decompression within the back pressure regulator 30, but an analyte that may lose solubility at the point of decompression is carried out through the post-decompression volume. In particular, an analyte that may have reduced solubility at the point of decompression is carried out through the outlet 37 of the outlet nut 36 and through the line 35, until it may be collected by the next collection vessel, such as collection vessel 40. The back pressure regulator 30 thus has a large post-decompression volume, including pockets of unswept volume, and the tortuous sample path (e.g. past orifice, seat 35, outlet nut 36, outlet 37 and line 35), which all work to promote analyte collection in the outlet of the back pressure regulator 30 and/or the line 35 and/or areas or volumes prior to the collection vessel. Analytes collecting in unswept areas of the system 100 result in carryover, loss of valuable extracted product, and/or a reduction in the purity of collected product.

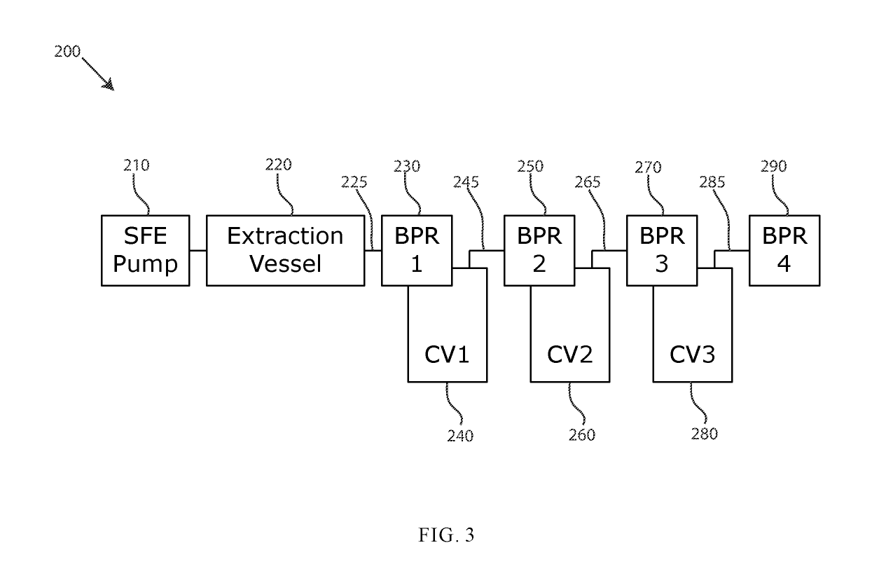

Referring now to FIG. 3, which depicts an extraction system 200, in accordance with embodiments of the present invention. Embodiments of the extraction system 200 may be a supercritical fluid or compressible fluid extraction system for extracting chemical compounds using a compressible solvent, such as carbon dioxide, instead of an organic solvent. Further, embodiments of the extraction system 200 may be a multi-vessel extraction system that may rapidly extract and fractionate large quantities of desired components from a multitude of matrices (e.g. samples). Moreover, embodiments of the extraction system 200 may include a pump 210, an extraction vessel 220, a first pressure control device 230, a first collection vessel 240, a second pressure control device 250, a second collection vessel 260, a third pressure control device 270, a third collection vessel 280, and a fourth pressure control device 290. The first pressure control device 230 may be integrated with the first collection vessel 240, the second pressure control device 250 may be integrated with the second collection vessel 260, the third pressure control device 270 may be integrated with the third collection vessel 280. Moreover, extraction system 200 may use a highly compressible solvent, such as CO₂, to dissolve a sample placed in the extraction vessel 220 by pressurizing the extraction vessel 220 with the compressible extraction solvent. The resultant extraction solvent stream containing the fully soluble analyte and the extraction solvent may be transferred to a collection vessel, where the extraction stream is depressurized, which causes the extraction solvent to lose solvating power and the analyte to fall from solution were it is collected in a collection vessel.

Embodiments of the extraction system 200 may include an extraction vessel 220, wherein a sample may be placed within the extraction vessel 220 and pressurized with an extraction solvent, at a first pressure. Embodiments of the extraction vessel 220 may be a tank, a vessel, a reservoir, a pressurized chamber, and the like, which may receive a sample delivered by the pump 220. The pump 210, which may deliver the compressible extraction solvent to the extraction vessel 220, may be fluidly connected to the extraction vessel. Further, embodiments of the extraction vessel 220 may be fluidly connected to a co-solvent pump, which may deliver a co-solvent, if necessary depending on the application, to the extraction vessel 220.

Embodiments of the extraction system 200 may include a first pressure control device 230 in fluid communication with the extraction vessel 220 via an extraction line 225, and configured to control a target pressure of the extraction vessel 220. For instance, an extraction solvent stream containing an analyte soluble in the extraction stream at the first pressure associated with the extraction vessel 220 may flow from the extraction vessel 220 to the first pressure control device 230 via the extraction line 225, which may be a line, connection tubing, a fluidic connector, a fluidic connection, a fluidic conduit, tubing, connection line, and the like. In the line 225, an analyte may be fully soluble in the extraction solvent stream at the first pressure associated with the extraction vessel 220. In an exemplary embodiment, the first pressure may range from 4000-6000 psi. In other embodiments, the first pressure may range from 4000-5000 psi. In further embodiments and applications, the first pressure may exceed 6000 psi, reaching pressures around 8000 psi to 8700 psi. The first pressure control device 230 may be integrated with a first collection vessel 240, and the first collection vessel 240 may have a second pressure, which is a lower pressure state than the first pressure. In an exemplary embodiment, the second pressure may range from 1800-2000 psi. In other embodiments, the second pressure may range from 2000-3000 psi. The first pressure control device 230 may be integrated with the first collection vessel 240 so that, at a point of decompression from the first pressure to the second pressure, an analyte falling from solution resulting from a drop in pressure is immediately collected in the first collection vessel 240. Embodiments of the first pressure control device may be a back pressure regulator, a pressure regulating device, a pressure regulator, a pressure control element, and the like.

Embodiments of the extraction system 200 may include a second pressure control device in fluid communication with the first collection vessel 240 via a line 245, and configured to control a target pressure of the first collection vessel 240. For instance, an extraction solvent stream containing an analyte soluble in the extraction stream at the second pressure associated with first collection vessel 240 may flow from the first collection vessel 240 to the second pressure control device 250 via the line 245, which may be a line, connection tubing, a fluidic connector, a fluidic connection, a fluidic conduit, tubing, connection line, and the like. In the line 245, an analyte may be fully soluble in the extraction solvent stream at the second pressure associated with the first collection vessel 240. The second pressure control device 250 may be integrated with a second collection vessel 260, and the second collection vessel 260 may have a third pressure, which is a lower pressure state than the second pressure associated with the first collection vessel 240. In an exemplary embodiment, the third pressure may range from 1000-1200 psi. In other embodiments, the third pressure may range from 900-1200 psi. The second pressure control device 250 may be integrated with the second collection vessel 260 so that at a point of decompression from the second pressure to the third pressure, an analyte falling from solution resulting from a drop in pressure is immediately collected in the second collection vessel 240. Embodiments of the second pressure control device may be a back pressure regulator, a pressure regulating device, a pressure regulator, a pressure control element, and the like.

Embodiments of the extraction system 200 may include a third pressure control device 270 in fluid communication with the second collection vessel 260 via an line 265, and configured to control a target pressure of the second collection vessel 260. For instance, an extraction solvent stream containing an analyte soluble in the extraction stream at the third pressure associated with second collection vessel 260 may flow from the second collection vessel 260 to the third pressure control device 270 via the line 265, which may be a line, connection tubing, a fluidic connector, a fluidic connection, a fluidic conduit, tubing, connection line, and the like. In the line 265, an analyte may be fully soluble in the extraction solvent stream at the third pressure associated with the second collection vessel 260. The third pressure control device 270 may be integrated with a third collection vessel 280, and the third collection vessel 280 may have a fourth pressure, which is a lower pressure state than the third pressure associated with the second collection vessel 260. In an exemplary embodiment, the fourth pressure may range from ambient pressure to 900 psi. In other embodiments, the fourth pressure may range from ambient pressure to 750 psi. The third pressure control device 270 may be integrated with the third collection vessel 280 so that at a point of decompression from the third pressure to the fourth pressure, an analyte falling from solution resulting from a drop in pressure is immediately collected in the third collection vessel 240. Embodiments of the third pressure control device may be a back pressure regulator, a pressure regulating device, a pressure regulator, a pressure control element, and the like.

Embodiments of the extraction system 200 may also include a fourth pressure control device 290, which may control a target pressure of the third collection vessel 280. Embodiments of the fourth pressure control device may be a back pressure regulator, a pressure regulating device, a pressure regulator, a pressure control element, and the like. In further embodiments, the extraction system 200 may include more than the three collection vessels and more than four pressure control devices. The number of pressure control devices and collection vessels may vary depending on the sample, a number of desired components being extracted, a required stepwise pressure reduction to extract the desired components, and other system and/or design requirements for a particular application. Embodiments of the extraction system 200 may include a single extraction vessel and a single collection vessel. Furthermore, embodiments of the integrated pressure control device and collection vessel may be appropriate for any extraction fluid which has a strong relationship between pressure (i.e. density) and solvating power. The fluid can be composed of a single solvent, or a mixture of fluid, liquid co-solvent, and additive. Alternative extraction fluids to CO₂ are possible, such as xenon, nitrogen, SF₆, chlorofluorocarbons (CFCs), fluorocarbons (FCs), nitrous oxide, various hydrocarbons, water, argon, etc. Common modifiers may include methanol, ethanol, isopropanol, acetonitrile, and water.

Accordingly, embodiments of the extraction system 200 may eliminate the low-pressure transport tubing from a pressure control device 230, 250, 270 to a collection vessel 240, 260, 280. Instead, if/when an analyte becomes no longer soluble or as a solubility of the analyte has been reduced in an extraction solvent stream due to the change/drop in pressure at the pressure control device 230, 250, 270, the analyte (e.g. a precipitate (solid) or a liquid component (liquid) is collected at the point of decompression where a decompression event occurs (e.g. drop in pressure from high pressure state to a low pressure state), as opposed to traveling along a fluid connection line or tubing connecting the pressure control device to the collection, as in the extraction system 100 described above.

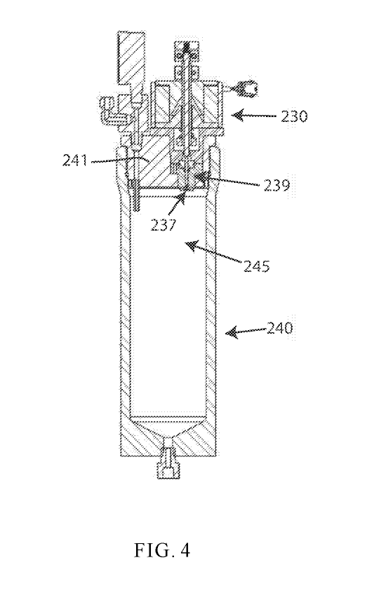

With continued reference to the drawings, FIG. 4 depicts a cross-sectional view of a pressure control device 230 integrated with a collection vessel 240, in accordance with embodiments of the present invention. Embodiments of the pressure control device, such as a back pressure regulator, integrated with a collection vessel may be described with reference to pressure control device 230, 250, 270, 290 and collection vessel 240 for convenience, but may be applicable to each of the pressure control devices 230, 250, 270, 290 and the collection vessels 240, 260, 280, respectively. Further, embodiments of pressure control device 230 for use with a compressible fluid extraction system 200 may include a body portion operably integrated with a first vessel 240, 260, 280. In an exemplary embodiment, an integrated body portion may refer to a body portion that is structurally integral with the vessel 240 or one or more components of the vessel 240. In another exemplary embodiment, an integrated body portion may refer to a body portion attached, adhered, fastened, or otherwise coupled to the vessel 240 or one or more components of the vessel 240. Embodiments of the fluid extraction system 200 may also include a pressure control element 239 configured to control a first pressure of a second vessel 220, 240, 260, 280 upstream of the first vessel 240, 260, 280, wherein a decompression event occurs at a point of decompression proximate an outlet 237 of the pressure control element 239 of the pressure control device 230, 250, 270, 290, wherein an analyte soluble in an extraction solvent stream at the first pressure but has reduced solubility in the extraction solvent stream at the pressure resulting from the decompression event drops out of solution and into the first vessel 240, 260, 280 at the point of decompression. The decompression event may also be referred to a drop in density, which is affected by a drop in pressure.

Embodiments of the integrated pressure control device 230 with collection vessel 240 may be operably attached to and/or integrated with a first vessel, such as collection vessel 240. The pressure control device 230 may be integrated with and/or otherwise coupled to various locations of the vessel 240. For example, the pressure control device 230 may be integrated with and/or coupled to a side of the vessel, a bottom of the vessel, a top of the vessel, and the like.

In an exemplary embodiment, the pressure control device 230 may be integrated a cap member 241 of the vessel 240. For instance, embodiments of the collection vessel 240 may include a cap member 241. The cap member 241 may be a cap, a cap member, a cover, a lid, or other vessel closing component that may be attached to a top end of the vessel 240 to maintain a pressurized state while also affording removable access to the interior 245 of the vessel 240. Embodiments of the cap member 241 may be a threaded cap member that includes outer threads that matingly correspond to an inner threaded surface of the vessel 240. For example, embodiments of the cap member 241 may be threadably attached to the collection vessel 240, as shown in FIG. 4. Other means to couple the cap member 241 to the collection vessel 241 may be used, such as removable fasteners, interference fit, and the like, provided that coupling means can withstand the pressure.

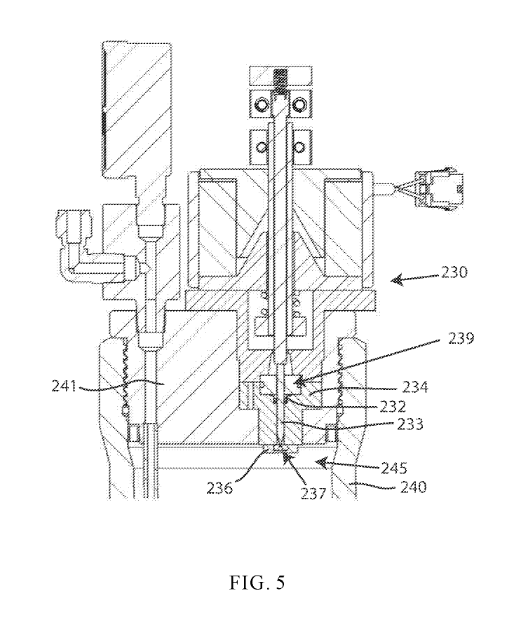

Furthermore, embodiments of the cap member 241 may be machined, modified, altered, manipulated, or otherwise configured to accept a pressure control element 239 of the pressure control device 230, so that the pressure control device 230 can be integrated with the collection vessel 240. FIG. 5 depicts an enlarged cross-sectional view of the pressure control device 230 being integrated with a collection vessel 240 as shown in FIG. 4, in accordance with embodiments of the present invention. Embodiments of the cap member 241 of the collection vessel 241 may receive, accept, accommodate, house, or otherwise surround a pressure control element 239 of the pressure control device 230. In an exemplary embodiment, the cap member 241 may include an opening to receive a head 234 and other body portions of the pressure control device 230, in an operable configuration. The opening may be one or more bores drilled into the cap member at one or more diameters to accommodate a shape of the head 234 of the pressure control device 230. The opening or area of the cap member 241 that may be formed into the cap member 241 may be accomplished using suitable machining methods. Moreover, the portion of the pressure control device 230 that may be accommodated within the cap member 241 may be configured to fit snugly within the receiving area of the cap member 241. In an exemplary embodiment, additional fasteners may be used to further attach the pressure control device 230 to the cap member 241 and/or the collection vessel 240. The portions or components of the pressure control device 230 integrated within the cap member 241 may include the head 234, the seal 232, the valve 233, a backup ring, and other portions of the back pressure regulator 230. In an alternative embodiment, components of the pressure control device 230 may be part of the cap member 241. For instance, the head 234 of the pressure control device 230 and other components of the pressure control device 230 may be structurally integral with the cap member 241, such that a one-piece configuration may be accomplished within the cap member 241.

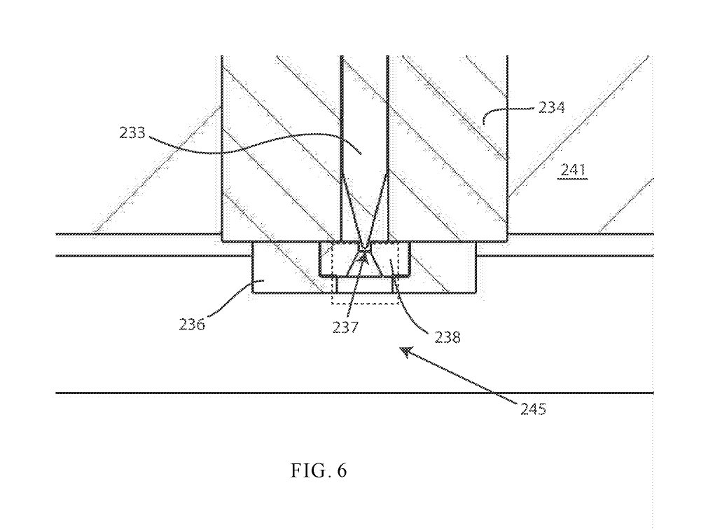

The pressure control device 230 may be positioned and/or integrated with the cap member 241 of the collection vessel 240 so that an outlet 237 of the pressure control device 230 is located within an interior region 245 of the collection vessel 240. The outlet 237 of the pressure control device 230 may be referred to as a point of decompression. FIG. 6 depicts an enlarged cross-section view of a point of decompression of the pressure control device 230 integrated with the collection vessel 240 of FIG. 5, in accordance with embodiments of the present invention. As shown in detail in FIG. 6, an outlet 237 of the pressure control device 230 may open up directly into the interior region 245 of the collection vessel 240, so that an analyte that is less soluble in the extraction solvent stream at a pressure zone associated with the collection vessel 240, may drop out of solution directly into the interior region of the collection vessel 240 (e.g. may fall to a bottom of the collection vessel 240 within the collection vessel 240). For instance, as the extraction solvent stream passes over the needle 233 and through an orifice between a tip of the needle 233 and a seat 238 of the pressure control element 239 of the pressure control device 230, a decompression event occurs due to a drop in pressure between a higher pressure state upstream of the orifice and a lower pressure state downstream from the orifice. Because a solvating power of the compressible solvent decreases with reduced pressure, the analyte may drop out of solution at the point of decompression, in response to the decompression event. Embodiments of the point of decompression may be an outlet side of the pressure control element 239, located within the vessel 240. In an exemplary embodiment, the point of decompression may be an area proximate the orifice, seat 238, and outlet 237 of the pressure control device 230, as shown enclosed in the dashed lines in FIG. 6. An analyte in the mobile phase may be soluble in an extraction solvent stream at the first pressure (i.e. pressure associated with the extraction vessel 220) but may have reduced solubility in the extraction solvent stream at the reduced pressure (e.g. pressure associated with the first collection vessel 240) resulting from the decompression event. As such, the analyte may drop out of solution and into the first collection vessel 240 at the point of decompression, wherein the point of decompression may be located within an interior 245 of the collection vessel 240 so that the analyte that may no longer be fully soluble does not need to be transported through additional connection line, tubing, etc. through low-pressure volumes.

Furthermore, FIG. 6 depicts a retaining member 236 that may be configured to retain, secure, tighten, etc. the seat 238 proximate the tip of the needle 233. For instance, embodiments of the retaining member 236 may include a generally axial opening therethrough, with an annular lip that extends radially inward from an inner surface of the retaining member 236. The annular lip may provide an engagement surface that engages with a bottom surface of the seat 238, and may drive the seat 238 towards the needle 233 when the retaining member 236 is tightened or otherwise operably attached to the cap member 241 of the collection vessel 240. In an exemplary embodiment, the annular lip of the retaining member 236 may hold the seat 238 into an operable position with respect to the needle 233. In an alternative embodiment, the retaining member 236 may be structurally integral with the cap member 241. Moreover, embodiments of the seat 238 may be a polymer material comprising a first opening and a second opening. The first opening may be defined by a generally axial opening starting from a top surface of the seat 238. The first opening may have a constant diameter, and may extend a distance from the top surface or first end of the seat 238 to a beginning of the second opening of the seat 238. Embodiments of the second opening of the seat 238 may be defined as a tapered opening within the seat 238 having a gradually increasing diameter towards a bottom surface or second end of the seat 238. The tip of the needle 233 may be positioned at a point within the first or second opening of the seat 238, which may determine a size or area of the orifice. The size or area of the orifice may affect pressure of the extraction solvent stream flowing through the closed-loop control system of the extraction system 200. In an exemplary embodiment, the mobile phase flows around the needle 233 and through the orifice formed between the needle 233 and the seat 238. As the flow of the mobile phase reaches the orifice and passes through the orifice, a decompression event may occur at this point of decompression, and an analyte no longer fully soluble at the reduced pressure may fall from solution and be collected at the point of decompression, located within the collection vessel 240.

Additionally, embodiments of the pressure control device 230 may include various pressure control or flow control devices. For example, in addition to the pressure control element 239 being a needle 233 and a seat 238, embodiments of the pressure control element of the back pressure regulator 230 may incorporate a diaphragm for controlling the flow of the extraction solvent stream through the extraction system 200. A diaphragm based pressure control element of the back pressure regulator may be similarly positioned and/or integrated with the cap member 241, such than an outlet of the pressure control element employing the use of a diaphragm may be located within an interior region of a collection vessel. As such, the outlet of the diaphragm pressure control element may be a point of decompression located within the collection vessel. Additionally, the pressure control device may incorporate a fixed or variable restrictor. Variable restrictors may include thermally modulated variable restrictors. Fixed restrictors may include linear, tapered, converging-diverging, integral, or fritted restrictors. The flow control or pressure control device may incorporate control loops with one or more pressure sensors or may operate passively.

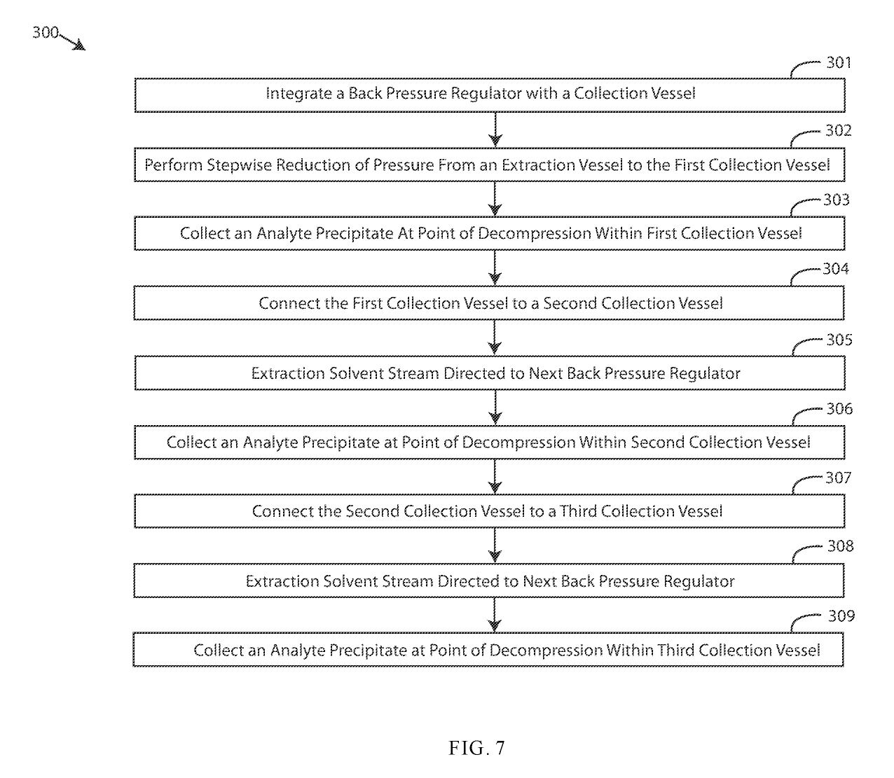

Referring now to FIG. 7, which depicts a flow chart of a method 300 for reducing post-compression transport volume of a compressible fluid extraction system, in accordance with embodiments of the present invention. The method may include adding a sample to the extraction vessel 222, pressurizing the extraction vessel 220 by a first pressure control device, and connecting the extraction vessel 220 to a collection vessel, prior to step 301. Step 301 integrates a pressure control device 230, 250, 270 with a collection vessel 240, 260, 280. Integrating the pressure control device 230, 250, 270 with the collection vessel 240, 260, 280 may include operably attaching the pressure control device 230, 250, 270 to the collection vessel 240, 260, 280 such that a point of decompression from a high pressure state to a low pressure state proximate a pressure control element 237 of the pressure control device 230, 250, 270 occurs within an interior region of the collection vessel 240, 260, 280. For example, in an operable configuration of a compressible fluid extraction system, such as extraction system 200, a pressure control element of a pressure control device is positioned within the collection vessel. Step 302 performs a stepwise reduction of pressure from an extraction vessel 220 to the first collection vessel 240. The stepwise reduction of pressure may be automatic and programmable using automated pressure control devices. Step 303 collects an analyte at the point of decompression when the analyte has reduced solubility in an extraction solvent stream at a pressure resulting from a decompression event at the point of decompression between the pressure state associated with the extraction vessel and the pressure state associated with the first collection vessel 240. Step 304 connects the first collection vessel 240 to an additional collection vessel 260 via a line carrying the extraction solvent stream from the collection vessel 240 to an additional pressure control device integrated with the additional collection vessel 260.

At step 305, the extraction solvent stream with the analyte soluble in the extraction solvent stream at the pressure associated with the first collection vessel 240 flows to the next back pressure regulator regulating the second collection vessel 260 and integrated therewith. Step 306 collects an analyte at the point of decompression when the analyte has reduced solubility in an extraction solvent stream at a pressure resulting from a decompression event at the point of decompression between the pressure state associated with the first collection vessel 240 and the pressure state associated with the second collection vessel 260. Step 307 connects the second collection vessel 260 to a third collection vessel 280 via a line carrying the extraction solvent stream from the collection vessel 260 to an additional pressure control device integrated with the additional collection vessel 280. At step 308, the extraction solvent stream with the analyte soluble in the extraction solvent stream at the pressure associated with the second collection vessel 260 flows to the next pressure control device regulating the third collection vessel 280 and integrated therewith. Step 309 collects an analyte at the point of decompression when the analyte has reduced solubility in an extraction solvent stream at a pressure resulting from a decompression event at the point of decompression between the pressure state associated with the second collection vessel 260 and the pressure state associated with the third collection vessel 260. Thus, method 300 may collect the analyte in a stepwise collection of analyte fractions based on a solubility in the extraction solvent stream at a given pressure, wherein the analyte is collected into the collection vessel at the point of decompression without being transported via tubing from an outlet of the back pressure regulator to an inlet of the collection vessel.

Solubility of an analyte in a compressible fluid is proportional to density. Density is controlled by pressure and temperature. In exemplary embodiments, the temperatures of extraction and collection vessels are independently controlled. Those skilled in the art realize that appropriate pressures to enable extraction and density-based fractionation may have to be altered to accommodate for the temperature of extraction and collection vessels.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A pressure control device for use with a compressible fluid extraction system, comprising:
a body portion integrated with a first vessel; and
a pressure control element configured to control a first pressure of a second vessel upstream of the first vessel, wherein a decompression event occurs at a point of decompression proximate an outlet of the pressure control element of the pressure control device;
wherein an analyte soluble in an extraction solvent stream at the first pressure but has reduced solubility in the extraction solvent stream at the pressure resulting from the decompression event drops out of solution and into the first vessel at the point of decompression.

2. The pressure control device of claim 1, wherein the decompression event is a drop in density from a high density state to a lower density state.

3. The pressure control device of claim 1, wherein the point of decompression is an outlet side of the pressure control element, located within the first vessel.

4. The pressure control device of claim 1, wherein the pressure control element is a needle and seat.

5. The pressure control device of claim 1, wherein the pressure control element is a diaphragm.

6. The pressure control device of claim 1, wherein the body portion is integrated with a cap member of the first vessel, the cap member being attached to an inner surface of the first vessel.

7. The pressure control device of claim 1, wherein the first vessel is a collection vessel of the compressible fluid extraction system.

8. The pressure control device of claim 1, wherein the second vessel is at least one of: an extraction vessel and a collection vessel.

9. An extraction system comprising:
an extraction vessel, wherein a sample is placed within the extraction vessel and pressurized with an extraction solvent, at a first pressure; and
a first pressure control device in fluid communication with the extraction vessel via an extraction fluidic connection line, and configured to control a target pressure of the extraction vessel, the first pressure control device being integrated with a first collection vessel, the first collection vessel having a second pressure, which is a lower pressure state than the first pressure, wherein the first pressure control device is integrated with the first collection vessel so that at a point of decompression from the first pressure to the second pressure, an analyte with reduced solubility resulting from a drop in pressure is immediately collected in the first collection vessel.

10. The extraction system of claim 9, further comprising:
a second pressure control device in fluid communication with the first collection vessel via a fluidic connection line, the second pressure control device being integrated with a second collection vessel, the second collection vessel having a third pressure, which is a lower pressure state than the second pressure, wherein the second pressure control device is integrated with the second collection vessel so that at a point of decompression from the second pressure to the third pressure, an analyte with reduced solubility resulting from a drop in pressure is immediately collected in the second collection vessel.

11. The extraction system of claim 9, wherein the extraction solvent is carbon dioxide.

12. The extraction system of claim 9 further comprising: a third pressure control device in fluid communication with the second collection vessel via a fluidic connection line, the third pressure control device being integrated with a third collection vessel, the third collection vessel having a fourth fluid pressure, wherein the third pressure control device is integrated with the third collection vessel so that at a point of decompression from the third pressure to the fourth pressure, an analyte with reduced solubility resulting from a drop in pressure is immediately collected in the third collection vessel.

13. The extraction system of claim 11, wherein the first pressure ranges from 4000-6000 psi, the second pressure ranges from 2000-3000 psi, the third pressure ranges from 900-1200 psi, and the fourth pressure ranges from ambient pressure to 900 psi.

14. The extraction system of claim 9, further comprising an extraction solvent pump for delivering the extraction solvent to the extraction vessel.

15. The extraction system of claim 9, further comprising a co-solvent solvent pump for delivering a co-solvent solvent to the extraction vessel.

16. A method for reducing post-decompression transport volume of a compressible fluid extraction system, the method comprising:
integrating a pressure control element with a collection vessel, wherein a point of decompression from a high pressure state to a low pressure state proximate a pressure control element of the pressure control device is positioned within the collection vessel, in an operable configuration of the compressible fluid extraction system; and
collecting an analyte at the point of decompression when the analyte has reduced solubility in an extraction solvent stream at a pressure resulting from a decompression event at the point of decompression.

17. The method of claim 16, further comprising: performing a stepwise reduction of pressure from an extraction vessel to the collection vessel.

18. The method of claim 16, wherein collecting the analyte is a stepwise collection of analyte fractions based on a solubility in the extraction solvent stream at a given pressure.

19. The method of claim 16, further comprising: connecting the connection vessel to an additional connection vessel via a fluidic connection line carrying the extraction solvent stream from the collection vessel to an additional pressure control device integrated with the additional collection vessel.

20. The method of claim 16, wherein the decompression event is a drop in pressure from the high density state to the lower density state.

21. The method of claim 16, wherein the point of decompression is an outlet side of the pressure control element, located within the first vessel.
